(19) United States
(12) Patent Application Publication
(10) Pub. No.: US 2026/0324688 A1
(43) Pub. Date: Oct. 22, 2026

(54) SUGAR-FREE POWDERED HYDRATION DRINK MIX

(71) Applicant: Conopco, Inc., d/b/a UNILEVER, Hoboken, NJ (US)

(72) Inventors: Sonia Bisla, Hoboken, NJ (US); Christopher John Moulton, Fort Wayne, IN (US); Sumeet Bindra Narang, Hoboken, NJ (US)

(73) Assignee: Conopco, Inc., d/b/a UNILEVER, Hoboken, NJ (US)

(21) Appl. No.: 19/690,085

(22) Filed: May 28, 2026

(30) Foreign Application Priority Data
Mar. 7, 2025 (EP) 25187387.3

(51) Int. Cl. A23L 2/39; A23L 2/60; A23L 2/68

(52) U.S. Cl. CPC A23L 2/39; A23L 2/60; A23L 2/68

(57) ABSTRACT

A powdered hydration drink mix composition which is mixable with water to create a hydration drink includes from about 35 to about 55%, by weight based on the total weight of the composition, of amino acids including at least L-glutamine, L-alanine, L-lysine, L-serine and L-threonine,

and from about 25 to about 45% by weight based on the total weight of the composition, of electrolyte sources including a source of sodium, a source of potassium, a source of calcium and a source of magnesium. The total amount of nutritive sweetener in the composition is 0 or does not exceed about 2% by weight based on the total weight of the composition.

### BACKGROUND

Hydration drinks offer a range of benefits for human health and performance. For athletes and active individuals, these formulations help replenish essential electrolytes like sodium and potassium lost during intense exercise, especially in hot weather or during prolonged workouts. Nonathletes may also find them helpful, for example when suffering from illnesses which dehydrate the body. Similarly, people living in or visiting regions with extreme heat can utilize hydration drinks to maintain optimal hydration levels and prevent heat-related illnesses.

Powdered hydration drink mixes are designed to be mixed with water by the consumer to create the hydration drink. They have become an increasingly popular format with consumers due to their portability and convenience. The powdered mixes typically come in compact, lightweight packaging such as pouches or sachets.

### SUMMARY

Powdered hydration drink mixes on the market often contain sugar to enhance palatability and to aid in the absorption of electrolytes and water. However, sugar can be undesirable for individuals who are conscious of sugar intake.

It is an objective to provide sugar-free powdered hydration drink mixes which can be mixed with water by a consumer to create a hydration drink that enhances fluid absorption and supports cellular hydration.

A powdered hydration drink mix composition which is mixable with water to create a hydration drink can comprise
from about 35 to about 55%, by weight based on the total weight of the composition, of amino acids including at least L-glutamine, L-alanine, L-lysine, L-serine and L-threonine, and from about 25 to about 45% by weight based on the total weight of the composition, of electrolyte sources including a source of sodium, a source of potassium, a source of calcium and a source of magnesium,
wherein the total amount of nutritive sweetener in the composition is 0 or does not exceed about 2% by weight based on the total weight of the composition.

### DETAILED DESCRIPTION

### Amino Acids

The composition comprises amino acids including at least L-glutamine, L-alanine, L-lysine, L-serine and L-threonine.

The amino acids may be used in free form or salt form or a mixture thereof. Examples of salt forms include inorganic acid addition salts such as hydrochloride salts.

In certain embodiments, L-glutamine is present in the composition in an amount such that when an approximately 10 g serving of the composition is mixed with water it provides from about 1000 to about 2000 mg L-glutamine.

In certain embodiments, L-alanine is present in the composition in an amount such that when an approximately 10 g serving of the composition is mixed with water it provides from about 200 to about 700 mg L-alanine.

In certain embodiments, L-lysine hydrochloride is present in the composition in an amount such that when an approximately 10 g serving of the composition is mixed with water it provides from about 800 to about 1400 mg L-lysine hydrochloride.

In certain embodiments, L-threonine is present in the composition in an amount such that when an approximately 10 g serving of the composition is mixed with water it provides from about 300 to about 500 mg L-threonine.

In certain embodiments, L-serine is present in the composition in an amount such that when an approximately 10 g serving of the composition is mixed with water it provides from about 300 to about 500 mg L-serine.

In certain embodiments, L-arginine is present in the composition in an amount such that when an approximately 10 g serving of the composition is mixed with water it provides from about 150 to about 250 mg L-arginine.

In certain embodiments, the composition comprises:
from about 14 to about 20%, such as from about 15.5 to about 17.5% of L-glutamine, by weight based on the total weight of the composition,
from about 3 to about 7.5%, such as from about 3.5 to about 6.5% of L-alanine, by weight based on the total weight of the composition,
from about 8 to about 14%, such as from about 9 to about 11% of L-lysine, by weight based on the total weight of the composition,
from about 2 to about 6%, such as from about 3 to about 5% of L-serine, by weight based on the total weight of the composition,
from about 2 to about 6%, such as from about 3 to about 5% of L-threonine, by weight based on the total weight of the composition, and
optionally, from about 1 to about 3%, such as from about 2 to about 2.5% of L-arginine, by weight based on the total weight of the composition.

The total level of amino acids in the composition suitably ranges from about 40 to about 50%, such as from about 43 about 45% by weight based on the total weight of the composition.

In certain embodiments, the composition comprises:
from about 14 to about 20%, such as from about 15.5 to about 17.5% of L-glutamine, by weight based on the total weight of the composition,
from about 3 to about 7.5%, such as from about 3.5 to about 6.5% of L-alanine, by weight based on the total weight of the composition,
from about 8 to about 14%, such as from about 9 to about 11% of L-lysine, by weight based on the total weight of the composition,
from about 2 to about 6%, such as from about 3 to about 5% of L-serine, by weight based on the total weight of the composition,
from about 2 to about 6%, such as from about 3 to about 5% of L-threonine, by weight based on the total weight of the composition, and
optionally, from about 1 to about 3%, such as from about 2 to about 2.5% of L-arginine, by weight based on the total weight of the composition, and
from about 40 to about 50%, such as from about 43 about 45% total amino acid, by weight based on the total weight of the composition.

### Electrolyte Sources

The composition comprises electrolyte sources including a source of sodium, a source of potassium, a source of calcium and a source of magnesium.

The source of sodium comprises at least one physiologically acceptable compound which provides sodium ions when mixed with water. In certain embodiments, the sodium source is selected from sodium chloride, sodium citrate and mixtures thereof.

In certain embodiments, the source of sodium is present in the composition in an amount such that when an approximately 10 g serving of the composition is mixed with water it provides from about 400 to about 600 mg sodium ions.

The source of potassium comprises at least one physiologically acceptable compound which provides potassium ions when mixed with water. In certain embodiments, the potassium source comprises potassium citrate, potassium gluconate and mixtures thereof.

In certain embodiments, the source of potassium is present in the composition in an amount such that when an approximately 10 g serving of the composition is mixed with water it provides from about 300 to about 500 mg potassium ions.

The source of calcium comprises at least one physiologically acceptable compound which provides calcium ions when mixed with water. In certain embodiments, the calcium source is selected from calcium citrate, calcium lactate, calcium gluconate, and mixtures thereof.

In certain embodiments, the source of calcium is present in the composition in an amount such that when an approximately 10 g serving of the composition is mixed with water it provides from about 60 to about 180 mg calcium ions.

The source of magnesium comprises at least one physiologically acceptable compound which provides magnesium ions when mixed with water. In certain embodiments, the magnesium source comprises magnesium citrate, magnesium lactate and mixtures thereof.

In certain embodiments, the source of magnesium is present in the composition in an amount such that when an approximately 10 g serving of the composition is mixed with water it provides from about 45 to about 65 mg magnesium ions.

The total level of electrolyte sources in the composition suitably ranges from about 30 to about 40%, such as from about 33 about 37% by weight based on the total weight of the composition.

In certain preferred embodiments, the composition comprises:
a source of sodium which is a mixture of sodium chloride and sodium citrate,
a source of potassium which is potassium citrate,
a source of calcium which is calcium citrate, and
a source of magnesium which is magnesium citrate; in an amount such when an approximately 10 g serving of the composition is mixed with water it provides from about 400 to about 600 mg sodium ions, about 300 to about 500 mg potassium ions, about 60 to about 180 mg calcium ions and about 45 to about 65 mg magnesium ions.

For instance, in certain embodiments, the composition comprises:
from about 5 to about 15%, such as from about 9 to about 10% of sodium chloride, by weight based on the total weight of the composition,
from about 3 to about 7.5%, such as from about 5 to about 6% of trisodium citrate dihydrate, by weight based on the total weight of the composition,
from about 8 to about 14%, such as from about 10 to about 11% of tripotassium citrate monohydrate, by weight based on the total weight of the composition,
from about 4 to about 86%, such as from about 5 to about 7% of tricalcium citrate tetrahydrate, by weight based on the total weight of the composition,
from about 2 to about 4.5%, such as from about 3 to about 4% of trimagnesium citrate anhydrous, by weight based on the total weight of the composition.

### Sweetener

Nutritive sweeteners, also known as caloric sweeteners or sugars, provide energy in the form of carbohydrates. Nutritive sweeteners commonly found in foods and beverages include glucose, fructose and sucrose.

The total amount of nutritive sweetener in the composition is 0 or does not exceed about 2% by weight based on the total weight of the composition.

In certain embodiments the total amount of nutritive sweetener in the composition is 0 or does not exceed about 1, or about 0.5, or about 0.1% by weight based on the total weight of the composition.

For instance, in certain preferred embodiments the total amount of nutritive sweetener selected from glucose, fructose and sucrose in the composition is 0 or does not exceed about 1, or about 0.5, or about 0.1% by weight based on the total weight of the composition.

### Optional Ingredients

The composition may contain a variety of optional ingredients, for example to enhance functional, aesthetic or organoleptic properties of the compositions.

Exemplary optional ingredients include vitamins, adaptogens, nootropics, fermentation-derived ingredients, botanical extracts, probiotics, hormones, non-nutritive sweeteners, colorants, acidulants, processing aids or any combination thereof.

Vitamins which may be used in the composition include vitamin A, vitamin B1, vitamin B2, vitamin B3, vitamin B5, vitamin B6, vitamin B7, vitamin B12, vitamin C, vitamin D, vitamin E, vitamin K, and any combinations thereof. In certain embodiments, the composition includes vitamin B and vitamin C, preferably vitamin B3, vitamin B5, vitamin B12, and vitamin C. In certain embodiments, the total amount of vitamins is about 0.5 to about 3%, such as about 1 to about 2% by weight based on the total weight of the composition.

Acidulants which may be used in the composition can serve any one or more of several functions, including, for example, providing antioxidant activity, lending tartness to the taste of the hydration drink, enhancing palatability, increasing thirst quenching effect, modifying sweetness and acting as a mild preservative by providing microbiological stability. Acidulants which may be used in the composition include citric acid, malic acid and tartaric acid and mixtures thereof. In certain embodiments, the composition includes citric acid. In certain embodiments, the amount of citric acid is about 10 to about 20%, such as about 12.5 to about 17.5 weight based on the total weight of the composition.

Non-nutritive sweeteners which may be used in the composition include acesulfame-K, alitame, aspartame, cyclamate, glycyrrhizin, NHDC, saccharin, Stevioside, sucralose, thaumatin, neotame, and Rebaudioside A. In certain embodiments, the composition includes Rebaudioside A. In certain embodiments, the amount of Rebaudioside A is about 0.5 to 3%, such as about 1 to about 2% by weight based on the total weight of the composition.

Processing aids which may be used in the composition include silicon dioxide, sodium aluminium silicate, magnesium stearate, rice hull powder, and any combinations thereof. In certain embodiments, the composition includes silicon dioxide. In certain embodiments, the amount of silicon dioxide is about 0.5 to 3%, such as about 1 to about 2% by weight based on the total weight of the composition.

Mixtures of any of the above-described materials may also be used.

### Packaging and Use

Many types of packaging can be used to store and deliver the composition, for example, a stick pack.

The composition is mixable with water to create a hydration drink. In certain embodiments, the packaging used to store and deliver the composition includes instructions to mix with the appropriate amount of water.

Accordingly, a process for preparation of a hydration drink is provided, with the process comprising the step of mixing the powdered hydration drink mix composition as described above with water. In certain embodiments, about 5 to about 15 g, such as about 10 g of the powdered hydration drink mix composition as described above is mixed with about 400 to about 600 ml, such as about 500 ml water.

The following non-limiting Examples are provided to further illustrate an understanding of embodiments.

### EXAMPLES

### Example 1

The following composition as shown in Table 1 below represents a powdered hydration drink mix composition.

TABLE 1

| Ingredient | mg | % w/w |
|---|---|---|
| Sodium citrate dihydrate | 540 | 5.4 |
| Tri potassium citrate monohydrate | 1050 | 10.6 |
| Sodium chloride | 960 | 9.7 |
| Vitamins (Vitamin B3, Vitamin B5, | 145 | 1.5 |
| Vitamin B12, Vitamin C) | | |
| Silicon dioxide | 150 | 1.5 |
| L-Glutamine | 1650 | 16.6 |
| L-Alanine | 619 | 6.2 |
| L-Lysine hydrochloride | 1276 | 12.8 |
| L-Serine | 386 | 3.9 |
| L-Threonine | 415 | 4.2 |
| Citric acid anhydrous | 1450 | 14.6 |
| Stevia extract (Rebaudioside A) | 130 | 1.3 |
| Flavoring material | 215 | 2.2 |
| Tricalcium citrate tetrahydrate | 598 | 6.0 |
| Trimagnesium citrate anhydrous | 365 | 3.7 |
| Total | 9949 | 100 |

When mixed with 500 ml water the composition of Example 1 forms a palatable hydration drink that enhances fluid absorption and supports cellular hydration.

### Example 2

### In-Vitro Study

A series of hydration drink mix compositions were prepared with ingredients as shown in Table 2. Example 2 represents a composition according to an embodiment. Examples A and B represent comparative examples (not according to the invention).

TABLE 2

| | Example | | | | | |
|---|---|---|---|---|---|---|
| | A | | 2 | | B | |
| Ingredient | % w/w | g | % w/w | g | % w/w | g |
| Base | 46.06 | 5.29 | 52.14 | 5.29 | 65.70 | 5.29 |
| Formula* | | | | | | |
| L-Glutamine | 22.18 | 2.55 | 14.79 | 1.50 | 18.60 | 1.50 |
| L-Alanine | 22.18 | 2.55 | 3.58 | 0.36 | 4.50 | 0.36 |
| L-Arginine | 1.74 | 0.20 | 1.97 | 0.20 | | |
| L-Lysine | | | 11.44 | 1.16 | | |
| HCI | | | | | | |
| L-Threonine | | | 3.72 | 0.377 | | |
| L-Serine | | | 3.46 | 0.351 | | |
| Calcium | 4.79 | 0.55 | 5.43 | 0.55 | 6.82 | 0.55 |
| Magnesium | 3.06 | 0.35 | 3.47 | 0.35 | 4.36 | 0.35 |
| Total | 100 | 11.49 | 100 | 10.14 | 100 | 8.06 |

*[Sodium source, potassium source, vitamin blend, citric acid, silicon dioxide, stevia, flavor]

The compositions of Table 2 were investigated for their effect on intestinal water absorption under controlled experimental conditions. Experiments were conducted using Caco-2/TC7 cells. Caco-2/TC7 cells represent a homogeneous population of epithelial cells derived from the classical Caco-2 lineage. These cells are seeded onto polycarbonate filters, enabling attachment and differentiation into a tight epithelial monolayer that closely mimics the intestinal barrier. Differentiation is carried out over 21 days to achieve confluence and maturation, with the monolayers ready for experimental use between days 21 and 31 post-seeding.

Upon maturation, the epithelial monolayer displays hallmark features of small intestinal enterocytes, including formation of an organized apical brush border, and presence of intercellular tight junctions, including ZO-1 and occludin.

The culture and maturation of Caco-2/TC7 monolayers was performed as described above and the Caco-2/TC7 monolayers validated by measuring the transepithelial electrical resistance (TEER). Only Caco-2/TC7 monolayers that meet the acceptance criteria (TEER >500 ohms) were used for the study.

The compositions of Table 2 were each mixed with water to provide test solutions at a fixed osmolarity of 185 mOsm, so that the different compositions could be directly compared.

The freshly prepared test solutions were added to the apical compartment of the Caco-2/TC7 monolayer while the basolateral compartment contained mannitol (25 mg/mL).

Appropriate controls were included in each experimental phase to ensure data validity and interpretability. Wells containing only assay medium in both the apical and basolateral compartments were used to establish baseline conditions for water absorption (negative control). As a positive control, mannitol (25 mg/mL) was added exclusively to the basolateral compartment, while the apical compartment contained only assay medium.

The liquid absorption by the intestinal epithelium is a result of the balance between the influx (apical to basolateral) and efflux (basolateral to apical) across the Caco2/TC7 barrier, given that the movement of water molecules across the barrier is bidirectional. For this reason, the measurement of remaining volume of liquid on the apical compartment over time is the best way to determine the effect of the test solutions on liquid absorption across the model.

The remaining liquid volume was measured in the apical compartment at the 3- and 6-hour time points by using an adjustable volume micropipette. The experiments were conducted in three independent assays (3 Runs), in duplicate. All the conditions, including the controls and treatments, were run in parallel to allow comparison among the treatments. Positive values represent reduction of apical volume (absorption), negative values represent increase of apical volume (excretion). The results are shown below in Table 3.

TABLE 3

| Volume of liquid | | | | | |
|---|---|---|---|---|---|
| absorption, over the | Negative | Positive | Example | Example | Example |
| time, expressed as μL | Control | Control | A | 2 | B |

3 h

| | | | | | |
|---|---|---|---|---|---|
| Mean | −3.67 | 21.33 | 13.60 | 15.00 | 16.00 |
| SEM | 7.31 | 3.26 | 1.06 | 4.69 | 1.63 |

6 h

| | | | | | |
|---|---|---|---|---|---|
| Mean | −4.67 | 34.67 | 13.00 | 13.67 | 10.83 |
| SEM | 10.23 | 4.75 | 1.91 | 4.41 | 4.17 |

| | | | |
|---|---|---|---|
| Total fluid movement (3 h + 6 h) | 26.6 | 28.66 | 26.83 |

It can be seen from the results that Example 2 (according to the invention) provides the highest fluid absorption in aggregate when compared to comparative Examples A and B respectively.

### Example 3

### Clinical Study

A clinical study was undertaken to investigate whether sugar-free formulations can achieve comparable hydration outcomes to sugar-containing formulations. Thirty participants enrolled and 22 participants (n=18 F; n=4 M) completed a double-blinded, randomized, placebo controlled, crossover trial to test the efficacy of three different electrolyte rehydration solutions versus placebo (flavor-matched water). Examples C and D represent comparative examples (not according to the invention) based on allulose and sugar alcohol respectively. Example 3 represents a formulation according to the invention. The ingredients are shown in Table 4 below.

TABLE 4
Example

| Placebo | C | 3 | D |
|---|---|---|---|
| Other ingredients | Sodium 510 mg | Sodium 510 mg | Sodium 700 mg |
| Stevia, flavour | Potassium 380 mg | Potassium 380 mg | Potassium 380 mg |
| | Vitamin C 76 mg | Vitamin C 76 mg | Vitamin C 76 mg |
| | Vitamin B3 24.9 mg | Vitamin B3 24.9 mg | Vitamin B3 15 mg |
| | Vitamin B5 11.7 mg | Vitamin B5 11.7 mg | Vitamin B5 5 mg |
| | Vitamin B6 2.53 mg | Vitamin B12 8 mcg | Vitamin B6 1.4 mg |
| | Vitamin B12 8 mcg | | Vitamin B12 2.4 mcg |
| | Glutamine, alanine, | Glutamine, alanine, arginine, | Soy powder, |
| | allulose | lysine, serine, threonine, | erythritol, glutamine, |
| | | magnesium, calcium | magnesium, calcium |
| | Other ingredients | Other ingredients | Other ingredients |
| | Citric acid, silicon dioxide, | Citric acid, silicon dioxide, | Citric acid, silicon dioxide, |
| | stevia, flavour | stevia, flavour | stevia, flavour |

All participants completed an exercise-induced dehydration (30 °C, 50% rh) to elicit a 2% body mass loss from sweat (1.70±0.29%), followed by a 60-minute rehydration period providing 150% of fluid lost. Linear mixed models were used for all primary objective analysis, with product as a fixed factor and participant ID as a random factor. The primary measure was net fluid balance.

Net fluid balance was calculated from change in body mass (kg) which represents fluid intake (mL), urine output (mL), and sweat loss (mL). Body mass (kg) was measured using a calibrated floor balance (HW-200KGL; A & D Weighing, Australia). Urine volume (mL) was collected in single use plastic containers and measured using a digital scale (IPro 2000; Next Shine, China), with urine specific gravity (ratio) and osmolarity (mOsm·kg⁻¹) measured using a clinical refractometer (300005; SPER Scientific, United States) and osmometer (Model 3320; Advanced Instruments, United States), respectively.

The results are shown in Tables 5 to 8 below.

TABLE 5
Descriptive data for body mass (kg) presented as mean (SD)
for each condition at each timepoint.

| Timepoint | Placebo | Example C | Example 3 | Example D |
|---|---|---|---|---|
| Start | 71.88 (12.36) | 72.06 (12.76) | 71.69 (12.79) | 71.84 (13.43) |
| rehydration | | | | |
| One hour | 73.60 (12.57) | 73.75 (12.97) | 73.40 (12.69) | 73.64 (13.30) |
| Two hours | 73.13 (12.59) | 73.33 (12.93) | 72.98 (12.71) | 73.32 (13.23) |
| Three hours | 72.67 (12.52) | 73.12 (12.93) | 72.76 (12.73) | 73.15 (13.21) |
| Four hours | 72.46 (12.52) | 73.01 (12.92) | 72.65 (12.70) | 73.03 (13.23) |
| Five hours | 72.35 (12.51) | 72.92 (12.92) | 72.56 (12.70) | 72.93 (13.20) |

TABLE 6
Descriptive data for urine output (mL) presented as mean (SD)
for each condition at each timepoint.

| Timepoint | Placebo | Example C | Example 3 | Example D |
|---|---|---|---|---|
| Start rehydration | 9.12 (12.26) | 8.82 (12.26) | 9.32 (14.20) | 6.89 (8.18) |
| One hour | 78.63 (58.97) | 85.03 (52.41) | 73.12 (65.37) | 86.44 (74.18) |
| Two hours | 407.83 (201.41) | 365.18 (205.74) | 366.17 (163.29) | 250.15 (118.82) |
| Three hours | 393.91 (169.81) | 162.14 (104.17) | 170.25 (81.22) | 127.30 (81.26) |
| Four hours | 173.18 (119.20) | 73.47 (54.29) | 60.04 (43.94) | 81.04 (54.49) |
| Five hours | 76.25 (61.66) | 66.12 (34.22) | 53.48 (39.28) | 59.31 (37.97) |
| Next AM | 9.12 (12.26) | 8.82 (12.26) | 9.32 (14.20) | 6.89 (8.18) |

TABLE 7
Descriptive data for urine specific gravity (ratio) presented as
mean (SD) for each condition at each timepoint.

| Timepoint | Placebo | Example C | Example 3 | Example D |
|---|---|---|---|---|
| Start | 1.025 (0.006) | 1.024 (0.005) | 1.029 (0.005) | 1.026 (0.005) |
| rehydration | | | | |
| One hour | 1.019 (0.009) | 1.024 (0.008) | 1.021 (0.007) | 1.023 (0.006) |
| Two hours | 1.007 (0.009) | 1.011 (0.008) | 1.007 (0.004) | 1.014 (0.006) |
| Three hours | 1.005 (0.006) | 1.017 (0.007) | 1.012 (0.004) | 1.018 (0.005) |
| Four hours | 1.009 (0.007) | 1.024 (0.007) | 1.018 (0.003) | 1.022 (0.005) |
| Five hours | 1.015 (0.007) | 1.027 (0.005) | 1.021 (0.004) | 1.022 (0.004) |
| Next AM | 1.024 (0.005) | 1.027 (0.007) | 1.024 (0.006) | 1.025 (0.006) |

TABLE 8
Descriptive data for urine osmolarity (mOsm · kg-1) presented as
mean (SD) for each condition at each timepoint.

| Timepoint | Placebo | Example C | Example 3 | Example D |
|---|---|---|---|---|
| Start rehydration | 702.42 (170.20) | 669.64 (110.65) | 758.27 (171.47) | 724.00 (185.08) |
| One hour | 511.44 (254.58) | 676.00 (243.05) | 630.44 (216.18) | 620.00 (208.68) |
| Two hours | 194.68 (243.08) | 253.32 (140.23) | 224.05 (141.13) | 366.36 (152.83) |
| Three hours | 140.18 (183.87) | 456.76 (174.12) | 361.41 (167.11) | 520.10 (145.69) |
| Four hours | 267.90 (191.07) | 601.22 (186.35) | 582.88 (162.88) | 595.74 (165.66) |
| Five hours | 443.28 (211.28) | 769.29 (150.71) | 662.65 (160.92) | 689.65 (159.79) |

### CONCLUSION

At two-, three- and four-hours post rehydration, all test products performed significantly better than placebo (p<0.05). Cumulative urine output, urine specific gravity, and urine osmolarity also indicated significantly better outcomes with all test products compared to placebo (p<0.05). Each of the test products were comparable showing similar superiority to placebo.

Specifically, the study results demonstrated that administration of the Example 3 formulation lacking carbohydrate or polyol resulted in a statistically significant increase in net fluid balance and a reduction in urine output relative to water. Hydration biomarkers, including urine specific gravity and urine osmolarity, consistently indicated enhanced fluid retention despite the absence of a carbohydrate-driven absorption mechanism. These effects were observed over multiple post-rehydration timepoints and support the conclusion that the formulation according to the invention provides improved post-dehydration fluid retention notwithstanding the absence of sugars or polyols.

1. A powdered hydration drink mix composition which is mixable with water to create a hydration drink; the composition comprising:
from about 35 to about 55%, by weight based on the total weight of the composition, of amino acids including at least L-glutamine, L-alanine, L-lysine, L-serine and L-threonine, and from about 25 to about 45% by weight based on the total weight of the composition, of electrolyte sources including a source of sodium, a source of potassium, a source of calcium and a source of magnesium,
wherein the total amount of nutritive sweetener in the composition is 0 or does not exceed about 2% by weight based on the total weight of the composition.

2. The composition according to claim 1, which comprises:
from about 14 to about 20%, such as from about 15.5 to about 17.5% of L-glutamine, by weight based on the total weight of the composition,
from about 3 to about 7.5%, such as from about 3.5 to about 6.5% of L-alanine, by weight based on the total weight of the composition,
from about 8 to about 14%, such as from about 9 to about 11% of L-lysine, by weight based on the total weight of the composition,
from about 2 to about 6%, such as from about 3 to about 5% of L-serine, by weight based on the total weight of the composition,
from about 2 to about 6%, such as from about 3 to about 5% of L-threonine, by weight based on the total weight of the composition, and
optionally, from about 1 to about 3%, such as from about 2 to about 2.5% of L-arginine, by weight based on the total weight of the composition, and
from about 40 to about 50%, such as from about 43 about 45% total amino acid, by weight based on the total weight of the composition.

3. The composition according to claim 1, which comprises:
from about 5 to about 15%, such as from about 9 to about 10% of sodium chloride, by weight based on the total weight of the composition,
from about 3 to about 7.5%, such as from about 5 to about 6% of trisodium citrate dihydrate, by weight based on the total weight of the composition,
from about 8 to about 14%, such as from about 10 to about 11% of tripotassium citrate monohydrate, by weight based on the total weight of the composition,
from about 4 to about 86%, such as from about 5 to about 7% of tricalcium citrate tetrahydrate, by weight based on the total weight of the composition,
from about 2 to about 4.5%, such as from about 3 to about 4% of trimagnesium citrate anhydrous, by weight based on the total weight of the composition.

4. The composition according to claim 1, in which the total amount of nutritive sweetener selected from glucose, fructose and sucrose is 0 or does not exceed about 1, or about 0.5, or about 0.1% by weight based on the total weight of the composition.

5. A process for preparation of a hydration drink, the process comprising the step of mixing a powdered hydration drink mix composition according to claim 1 with water.

6. The process according to claim 5, in which about 5 to about 15 g of the composition is mixed.

7. The process according to claim 5, in which about 400 to about 600 ml water is mixed.

8. A hydration drink prepared by the process according to claim 5.
